(19) United States
(12) Patent Application Publication
(10) Pub. No.: US 2025/0158892 A1
(43) Pub. Date: May 15, 2025

(54) ENABLING SERVICE API ANALYTICS IN A WIRELESS COMMUNICATIONS SYSTEM

(71) Applicant: Lenovo (Singapore) Pte. Limited, Singapore (SG)

(72) Inventors: Emmanouil Pateromichelakis, Viersen (DE); Dimitrios Karampatsis, Ruislp (GB)

(73) Assignee: Lenovo (Singapore) Pte. Limited, Singapore (SG)

(21) Appl. No.: 18/839,331

(22) PCT Filed: Mar. 23, 2022
(86) PCT No.: PCT/EP2022/057713

§ 371 Date: Aug. 16, 2024

(30) Foreign Application Priority Data
Feb. 18, 2022 (GR) 20220100152

(51) Int. Cl. H04L 41/14; H04L 67/53

(52) U.S. Cl. CPC H04L 41/14; H04L 67/53

(57) ABSTRACT

There is provided a network node of a wireless communications system, the network node arranged to provide analytics for one or more service APIs to a consumer of a service API, the service API for a service produced by one or more service producers at the wireless communications system. The network node comprises a transceiver and a processor. The transceiver is arranged to receive a request for a service API analytics event from the consumer, the request comprising a requirement for service API information. The processor is arranged to collect service API logs from one or more API source based on the service API analytics event, and to derive analytics for the one or more service APIs based on the collected service API logs to produce at least one service API analytics parameter. The transceiver further arranged to transmit the at least one service API analytics parameter to the consumer.

### FIELD

The subject matter disclosed herein relates generally to the field of enabling service API analytics in a wireless communications system. This document defines a network node in a wireless communications system, and a method in a network node in a wireless communications system.

### BACKGROUND

An application programming interface (API) facilitates a connection between computers or between computer programs. It is a type of software interface, offering a service to other pieces of software. A document or standard that describes how to build or use such a connection or interface is called an API specification. A computer system that meets this standard is said to implement or expose an API.

Wireless communications networks, such as those defined by the 3rd Generation Partnership Project (3GPP) use many APIs for providing services between nodes and functions within the communications network and between nodes of the communications network and external applications. Further, some APIs are exposed to third party applications to allow such third-party applications to consume services provided by a node or function within the communications network. In such an instance the third-party application may be a service consumer. For example, APIs are offered by the Mobile Network Operator (MNO) and Edge Cloud Service Provider (ECSP), for example. The APIs may comprise Network Exposure Function (NEF) APIs, Network Data Analytics Function (NWDAF) APIs, Mobile Edge Computing (MEC) APIs, Service Enabler Application Layer (SEAL) APIs, and Radio Access Network Intelligent Controller (RIC) APIs, for example. Some of these APIs may report similar parameters or affect the same resources. APIs relating to a service may be referred to as Service APIs.

### SUMMARY

A problem with having a plurality of APIs reporting similar parameters or affect the same resources is that a decision is required to determine which API to use for a particular situation. Disclosed herein are procedures for enabling service API analytics in a wireless communications system. Said procedures may be implemented by network node in the wireless communications system. The disclosed procedures may facilitate the use of predictive analytics for enabling a consumer, such as an Application Server or a client, to decide which API to invoke for consuming a service.

There is provided a network node of a wireless communications system, the network node arranged to provide analytics for one or more service APIs to a consumer of a service API, the service API for a service produced by one or more service producers at the wireless communications system. The network node comprises a transceiver and a processor. The transceiver is arranged to receive a request for a service API analytics event from the consumer, the request comprising a requirement for service API information. The processor is arranged to collect service API logs from one or more API source based on the service API analytics event, and to derive analytics for the one or more service APIs based on the collected service API logs to produce at least one service API analytics parameter. The transceiver further arranged to transmit the at least one service API analytics parameter to the consumer.

There is further provided a method in a network node of a wireless communications system, the method for providing analytics for one or more service APIs to a consumer of a service API, the service API for a service produced by one or more service producers at the wireless communications system. The method comprises receiving a request for a service API analytics event from the consumer, the request comprising a requirement for service API information. The method further comprises collecting service API logs from one or more service API sources based on the service API analytics event. The method further comprises deriving analytics for the one or more service APIs based on the collected service API logs to produce at least one service API analytics parameter. The method further comprises transmitting the service API analytics parameter to the consumer.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for enabling service API analytics in a wireless communications system will now be described, by way of example only, with reference to the accompanying drawings, in which:

FIG. 1 illustrates the architecture for enabling edge applications in accordance with 3GPP TS 23.558 v 17.2.0;

FIG. 2 depicts a user equipment apparatus that may be used for implementing the methods described herein;

FIG. 3 depicts further details of the network node that may be used for implementing the methods described herein;

FIG. 4 illustrates a method in a network node in a wireless communications system;

FIG. 5 illustrates a system for implementing a solution presented herein;

FIG. 6 is a signaling diagram illustrating a method for processing service API logs at an ADAES or SEAL;

FIG. 7 illustrates a system for implementing another solution presented herein; and

FIG. 8 illustrates a method of operation of the system.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

3GPP wireless communications networks use many APIs. APIs may be used in a 3GPP wireless communications network to provide control, application enablement and management services. For example, APIs are offered by the Mobile Network Operator (MNO) and Edge Cloud Service Provider (ECSP), for example. The APIs may comprise Network Exposure Function (NEF) APIs, Network Data Analytics Function (NWDAF) APIs, Mobile Edge Computing (MEC) APIs, Service Enabler Application Layer (SEAL) APIs, and Radio Access Network Intelligent Controller (RIC) APIs, for example. Some of these APIs may report similar parameters or affect the same resources.

This document addresses the problem of how to derive analytics for enabling a consumer, such as an Application Server or a client to decide which API to invoke for consuming a service.

In 3GPP SA2, data analytics services are provided by the NWDAF (TS 23.288 v17.3.0) and aim to support network data analytics services in 5G Core network. Such analytics can collect data from other Network Functions (NFs), or Application Function (AF) or Operation Administration and Management (OAM) and can be exposed to the third-party AF to provide statistics and predictions related to slice Load level, observed Service experience, NF Load, Network Performance, user equipment (UE) related analytics (such as mobility, communication), User data congestion, Quality of Service (QoS) sustainability, Data Network (DN) performance, etc.

In vertical scenarios, further data analysis on top of the 5G System (5GS) may be needed, to provide a useful output to the application specific layer for the end-to-end application service, including the application server related and application session related statistics/predictions. The statistics/predictions may be supported and/or enhanced by collecting data from different domains based on the consumer needs. Such collection can be from the 5GS via northbound APIs (NWDAF, Management Data Analytics Service (MDAS)), an application specific layer, a DN (e.g., data may be related to collecting HD maps, camera feeds, sensor data, data related to edge/cloud resources, data related to application server status (e.g., load of EAS/AS), or data from the UE side (e.g. UE routes/trajectories)). So, the application data collection may be provided by different sources (e.g. vertical-specific server, application of the UE, EAS, 3rd party server, SEAL). In order for the analytics enablement layer to generate statistics related to past use and/or predictions related to future use, a mechanism is required by which API data can be collected.

An application service provider (ASP) needs to be aware of the expected and/or predicted status of the service APIs provided by the underlying wireless communications systems which can be potentially consumed for the application service. For example, in one case multiple Public Land Mobile Networks (PLMNs) may offer similar services and as such the ASP would choose from which Mobile Network Operator (MNO) APIs should be invoked for consuming services. Herein, the service refers to a control, management or application enablement service, whereas the application service is for example the V2X, IoT, eMBB application which is provided by the application service provider (ASP) and uses the wireless communication system to provide communication between two or more applications. Service APIs provide a mechanism for exposing services to the applications which operate the application service. For example, a Core Network service is exposed via a NEF API to a V2X application server for supporting the V2X application service.

Another case is that a service may be provided by the MNO or by an edge/cloud provider (e.g. a Hyperscaler). For the latter, the edge/cloud provider may consume MNO services and re-sell them to the ASP, or may provide its own telco services. The ASP may wish to choose whether to invoke an API from either the MNO or from the Edge Cloud Service Provider (ECSP). One criterion upon which this choice may be based is the service performance and availability. The service performance and availability of both the MNO and ECSP can be determined from collected API status and/or analytics.

Different instances of the same service may be deployed in different edge and/or cloud platforms. For example, multiple NWDAF instances may provide analytics for the AF and reside in edge, regional or core clouds. In such an arrangement, the API producer is the NWDAF instance (or the NEF instance). The ASP may determine which NWDAF to use by making a prediction based on the determined NWDAF API load and stability analytics.

An application server at the ASP and/or vertical side may be deployed as an edge native application. The main drivers for edge native application development include the light and simplified design and the support for application portability. For this case, the support for API analytics at the edge (related to the API performance, failure, availability), is useful for such edge native applications to allow for dynamically deciding to scale-in from the edge to the cloud in heavy load situations, or scale out from the cloud to the edge to improve the quality of experience for the end user.

Some services may be offered with different granularity by different domains of the MNO or from the UE side. For example, 1) network QoS monitoring and prediction can be provided by the 5G core (5GC), 2) performance monitoring including QoS for a specific area or a service profile can be provided by OAM, 3) application QoS monitoring (end to end QoS between two or more applications using 5GS for communicating) by the app of the UE, 4) QoS and/or Quality of Experience (QoE) calculated at the edge. All these offerings are provided via QOS APIs but may have different granularities. Accordingly, it may be beneficial for the ASP to select, based on the API conditions, what service to consume and what API to call.

Other examples of APIs include Location API, Data Collection API, Analytics API. These APIs can be provided by different services and deployed by different domains. This capability will allow for predicting which API is the best to use based on the feature to be exposed and the exposure level required by the App Server

This document provides a mechanism by which API logs in a wireless communications network are collected and exposed to an ASP. Further, this document provides a mechanism by which the ASP may select which service API to invoke for consuming a service.

In 3GPP, analytics have been provided from a 5GC perspective, enablement layer as well as from OAM perspective. The NWDAF is defined in SA2, TS 23.288 v17.3.0. The NWDAF provides analytics services at the 5GC side and can expose the analytics to other NFs via Service Based Interface (SBI) APIs and to AF via NEF or Common API Framework (CAPIF) APIs.

Some analytics services collect data from user-plane sessions (from UPF and/or AF) and are necessary for the application server to get predictions or statistics from NWDAF. Examples of such analytics services are the following:
Observed Service Experience related network data analytics include: Service experience for a UE or a group UEs or any UE in an Application or a set of Applications over a specific UP path (UPF, DNAI and Edge Cloud server);
WLAN performance analytics (UE UL/DL data rate and traffic volume);
UE communication analytics (NWDAF collects UE UL/DL data rate and traffic volume from UPF and N4 session level data);
User data congestion analytics;
NWDAF gets from UPF or AF: UL/DL throughput and peak UL/DL throughput
Redundant Transmission Experience related analytics (UL/DL packet delay from UE to UPF);
DN Performance Analytics (performance data from AF like Average Packet Delay, Average Loss Rate and Throughput);
QoS sustainability analytics.

The Management Data Analytics Service (MDAS) is defined in SA5, TS 28.533 v17.1.0). The MDAS provides data analytics of different network related parameters including for example load level and/or resource utilization. For example, the MDAS for a network function (NF) can collect the NF's load related performance data, e.g. resource usage status of the NF. The analysis of the collected data is per area, slice or slice subnet, and may provide forecast of resource usage information in a predefined future time. This analysis may also recommend appropriate actions e.g. scaling of resources, admission control, load balancing of traffic, etc.

The Application Data Analytics Enabler Server (ADAES) will be defined in SA6, TR 23.700-36) and will provide application data analytics services (stats/predictions) to optimize the application service operation by notifying the application specific layer, and potentially 5GS, for expected/predicted application service parameters changes considering both on-network and off-network deployments (e.g. related to application QoS parameters).

Providing real-time data to a data analytics function is a challenging task. This may be complex and have a high signaling requirement. Further, due to the real-time nature of measurements (per transmission time interval TTI) this information may get quickly outdated and unsuitable for providing real time predictions.

Also, the retrieved data alone may not be sufficient to calculate a prediction. The data analytics service may also run models, which may be simulations of what-if scenarios for deriving different sets of data per worst case scenario. Such modelling may be useful for the vertical customers, since the MNO can guarantee a certain predictive performance based on the modelling.

In 3GPP, the exposure of APIs to third parties can be performed via NEF/CAPIF or via Exposure Governance Management Function (EGMF) or via enablement APIs. In SA2, some examples of NEF APIs related to the exposure to verticals and/or ASPs are shown in the following table.

TABLE 1
Example NEF APIs

| Service Name | Description |
|---|---|
| Nnef_EventExposure | Provides support for event exposure. |
| Nnef_ParameterProvision | Provides support to provision information |
| | which can be used for the UE in 5GS. |
| Nnef_Trigger | Provides support for device triggering. |
| Nnef_TrafficInfluence | Provide the ability to influence traffic routing. |
| Nnef_AfsessionWithQoS | Requests the network to provide a specific |
| | QoS for an AS session. |
| Nnef_ServiceParameter | Provides support to provision service specific |
| | information. |
| Nnef_APISupportCapability | Provides support for awareness on availability |
| | or expected level of a service API. |
| Nnef_AnalyticsExposure | Provides support for exposure of network |
| | analytics. |
| Nnef_Location | Provides the capability to deliver UE location |
| | to AF. |
| Nnef_AMInfluence | Provides the ability to influence access and |
| | mobility management related policies for one |
| | or multiple Ues. |
| Nnef_EASDeployment | EAS deployment service. |
| Nnef_UEId | UE Identifier service, which supports to |
| | retrieve AF specific UE Identifier based on |
| | UE address. |

Using the above exemplary services, Nnef_APISupportCapability may provide support for awareness on availability or expected level of a service API. In particular, an AF may subscribe to receive notification about the availability or expected level of support of a service API for a UE or a group of Ues. As a result of such a subscription, the AF is then notified about the availability or expected level of support of a service API for a UE or a group of Ues.

In SA5, the Management Services (MnS) are exposed in a service-based manner, via Exposure Governance Management Function (EGMF) to other management domains, or via BSS to third party customer (e.g. using TMF APIs). It is possible that the MnS API can be exposed directly by third party applications from the Operation Support System (OSS) (without crossing the Business Support System (BSS)); 11his details can be found at 3GPP TR 28.824 v0.5.0.

In SA6 a list of APIs can be provided to the third party application servers (which can be VAL servers or Edge Application Servers, for example). APIs are defined for different types of enablement services, as follows:
Edge Applications (EDGEAPP, TS 23.558 v17.2.0)
Service Enabler Application Layer (SEAL, TS 23.434 v17.4.0)
Vehicle-to-Everything Applications (V2XAPP, TS 23.286 v 17.3.0)
Uncrewed Aerial Systems Applications (UASAPP, TS 23.255 v17.2.0).

Some of the exposed API re-use or abstract the capabilities provided by NEF services. Such APIs include the Location Services exposure, QOS APIs, UP path information, for example.

In SA6 [TS 23.222 v17.5.0, TS 29.222 v17.3.0], a Common API Framework (CAPIF) was developed to enable a unified Northbound API framework across 3GPP network functions, and to ensure that there is a single and harmonized approach for API development. Some key functionalities in CAPIF are:
CAPIF Core Function (CCF) is a repository of all, PLMN and third party, service APIs;
API Exposing Function (AEF) is the provider of the services as APIs;
API Invoker is typically the applications that require service from the service providers;
API management function enables the API provider to perform administration of the service APIs, this includes auditing the service API invocation logs received from the CAPIF core function, and Monitoring the events reported by the CAPIF core function, etc.;
API publishing function enables the API provider to publish the service APIs information in order to enable the discovery of service APIs by the API invoker.

The CAPIF is hosted within the PLMN operator network or trust domain. The API invoker is typically provided by a third party application provider that has a service agreement with the PLMN operator. The API invoker may reside within the same trust domain as the PLMN operator network.

In a reference point based model, the API invoker within the PLMN trust domain interacts with the CAPIF via CAPIF-1 and CAPIF-2. The API invoker from outside the PLMN trust domain interacts with the CAPIF via CAPIF-1e and CAPIF-2e. The API exposing function, the API publishing function and the API management function of the API provider domain are together known as API provider domain functions. API provider domain functions within the PLMN trust domain interact with the CAPIF core function via CAPIF-3, CAPIF-4 and CAPIF-5 respectively.

ETSI defined Mobile Edge Computing (MEC) allows the exposure of APIs from RAN to MEC platforms. The exposure of APIs from UE/RAN to the service provider may relate to the UE location information, Bandwidth management, Radio Network Information (RNI). The ETSI document GS MEC 012 v2.1.5 specifies the RNI API exposure from RAN to MEC. More specifically, Radio Network Information Service (RNIS) is a service that provides radio network related information to MEC applications and to MEC platforms. The granularity of the radio network information may be adjusted based on parameters such as information per cell, per User Equipment, per QoS class or it may be requested over period of time. The Radio Network Information may be used by the MEC applications and MEC platform to optimize the existing services and to provide new type of services that are based on up-to-date information on radio conditions.

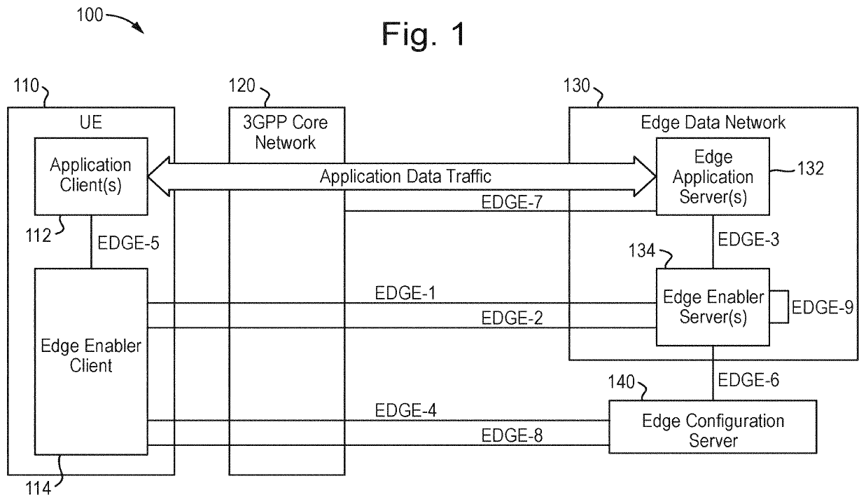

In 3GPP SA6, the EDGEAPP work specifies the application layer architecture for edge service. FIG. 1 illustrates the architecture for enabling edge applications in accordance with 3GPP TS 23.558 v 17.2.0. FIG. 1 shows a system 100 comprising a user equipment (UE) 110, a 3GPP Core Network 120, an Edge Data Network 130, and an edge configuration server (ECS) 140. UE 110 comprises at least one Application Client (AC) 112 and an Edge Enabler Client (EEC) 114. The Edge Data Network 130 comprises at least one Edge Application Server (EAS) 132 and an Edge Enabler Server (EES) 134.

The Edge Enabler Server (EES) 134 provides supporting functions needed for Edge Application Servers 132 and Edge Enabler Client 114, such as:
a) provisioning of configuration information to Edge Enabler Client 114,
b) enabling exchange of application data traffic with the Edge Application Server 132;
c) interacting with 3GPP Core Network 120 for accessing the capabilities of network functions either directly (e.g. via PCF) or indirectly (e.g. via SCEF/NEF/SCEF+NEF);
d) supports external exposure of 3GPP network capabilities to the Edge Application Server(s) 132 over EDGE-3.

The Edge Enabler Client (EEC) 114 provides supporting functions needed for Application Client(s) 112, such as retrieval and provisioning of configuration information to enable the exchange of Application Data Traffic with the Edge Application Server 132; and discovery of Edge Application Servers 132 available in the Edge Data Network 130.

The Edge Configuration Server (ECS) 140 provides supporting functions needed for the Edge Enabler Client 114 to connect with an Edge Enabler Server 134. The functionalities of the Edge Configuration Server 140 are related to the provisioning of edge configuration information to the EEC 114, which are used for establishing connection with EES 134.

The Edge Application Server (EAS) 132 is the application server resident in the Edge Data Network 130, performing the server functions.

The Application Client (AC) 112 is the application resident in the UE 110 performing the client function.

The APIs provided by the EDGEAPP framework are summarized in TS 23.558 v17.2.0 in the tables reproduced below.

TABLE 2
APIs provided by the ECS

| | Known |
|---|---|
| API Name | Consumers |
| Eecs_ServiceProvisioning | EEC |
| Eecs_EESRegistration | EES |
| Eecs_TargetEESDiscovery | EES |

TABLE 3
APIs provided by the EES

| | Known |
|---|---|
| API Name | Consumers |
| Eees_EECRegistration | EEC |
| Eees_EASRegistration | EAS |
| Eees_EASDiscovery | EEC |
| Eees_UELocation | EAS |
| Eees_ACRManagementEvent | EAS |
| Eees_AppClientInformation | EAS |
| Eees_UEIdentifier | EAS |
| Eees_Session WithQoS | EAS |
| Eees_TargetEASDiscovery | EAS, EES |
| Eees_AppContextRelocation | EEC, EAS |
| Eees_ACREvents | EEC |
| Eees_EELManagedACR | EAS |
| Eees_EECContextPull | EES |
| Eees_EECContextPush | EES |
| Eees_SelectedTargetEAS | EAS |
| Eees_ACRStatus Update | EAS |

O-RAN [https://www.o-ran.org/] is an alliance which investigates the virtualization of access domain and considers the virtualization of control functionalities (Radio Resource Management/Radio Resource Control (RRC/RRM)) to a newly defined RAN Intelligent Controller (RIC) which may be co-located with the gNB or can be deployed for a cluster of gNBs. In this context, given the deployment and the functional requirements (real-time, non-real time, near real-time) as well as the slice isolation policies, the RRM/RRC functionalities can be either flexibly located either at the CU/DU or to dedicated RIC controllers, e.g. Near-real-time (Near-RT) RIC and Non-real-time (Non-RT) RIC.

O-RAN is discussing the QoE/QoS optimization as possible AI-enabled feature which is deployed at the near-RT RIC (as third party xAPP or proprietary xAPP). In this context, the task of checking QoS upgrade/downgrade may be assisted by the use of RIC; and the interfaces which need to be considered are Open APIs.

Near-RT RIC provides a set of APIs to third party applications (which may be xApps). Such APIs include:
A1 related APIs: APIs allowing to access A1 related functionality (A1 is the interface between the OAM of the O-RAN operator and the RIC).
E2 related APIs: APIs allowing to access E2 related functionality and associated xApp Subscription Management and Conflict Mitigation functionality (E2 is the interface between the RAN nodes aka E2 nodes, and the RIC).
Management APIs: APIs allowing to access management related functionality. These are used for services such as O1 Termination, management services and logging, tracing, metrics collection.
SDL APIs: APIs allowing to access Shared Data Layer (SDL) related functionality.
Enablement APIs: APIs between xApps and API enablement functionality.

3GPP analytics (such as those provided by NWDAF, MDAS, and ADAES) do not provide analytics services in relation to an API status, API load, or success and failures, and further these do not consider predictions made in relation to the API and which may be used by a consumer.

The Application Function (AF) is able to receive API availability and service level based on a request. However, this is only for the control plane/NEF APIs and it is not based on analytics, and as such no notion of API status prediction is known.

The CAPIF can provide service API logs based on API invoker. However, this does not cover the collective API logs for all present and past API invokers which utilize (d) the target service API. Further, CAPIF has no capability to perform an analytics service such as making predictions based on the logs.

In some implementations (for example Service-Based Architecture (SBA)), the use of HTTP logs servers could provide support for API logs collection (usually this is internal servers, not standardized), however due to the fact that there are multiple types of APIs spanning across different domains, such an entity would need to be specified and be enhanced to collect logs from multiple domains and further modified to process and abstract logs before exposing them to the service provider.

There is a problem concerning how to collect API logs and derive API analytics at the edge and/or core network in a manner suitable for these to be exposes to a third-party consumer or Service Provider. The present application presents a solution to this problem.

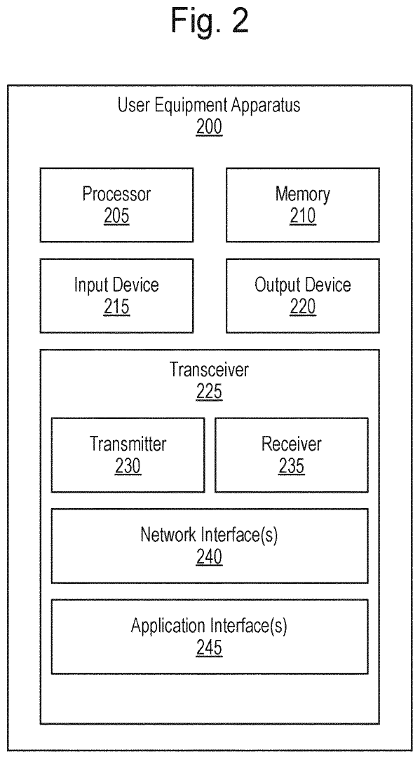

FIG. 2 depicts a user equipment apparatus 200 that may be used for implementing the methods described herein. The user equipment apparatus 200 is used to implement one or more of the solutions described above. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit.

Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

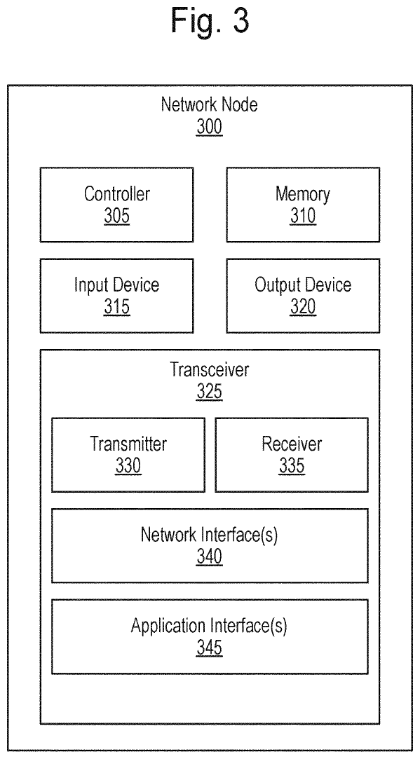

FIG. 3 depicts further details of the network node 300 that may be used for implementing the methods described herein. The network node 300 may be one implementation of an entity in the wireless communications network. The network node 300 includes a controller 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the controller 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The controller 305 may include any known controller capable of executing computer-readable instructions and/or capable of performing logical operations. For example, the controller 305 may be a microcontroller, a microprocessor, a CPU, a GPU, an auxiliary processing unit, a FPGA, or similar programmable controller. The controller 305 may execute instructions stored in the memory 310 to perform the methods and routines described herein. The controller 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also stores program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

There is provided a network node of a wireless communications system, the network node arranged to provide analytics for one or more service APIs to a consumer of a service API, the service API for a service produced by one or more service producers at the wireless communications system. The network node comprises a transceiver and a processor. The network node may be a network node 300 comprising a transceiver 325 and a processor 305. The transceiver is arranged to receive a request for a service API analytics event from the consumer, the request comprising a requirement for service API information. The processor is arranged to collect service API logs from one or more API source based on the service API analytics event, and to derive analytics for the one or more service APIs based on the collected service API logs to produce at least one service API analytics parameter. The transceiver further arranged to transmit the at least one service API analytics parameter to the consumer.

The network node may comprise an AAE, ADAES or CAPIF function. The request for a service API analytics event may include an API name or API type. The API source may be an API producer or a logs server.

The request for a service API analytics event comprises an application service profile or requirement, an API identifier, an API type, a time horizon for the analytics event, an area of validity, a reporting configuration, or a combination thereof. The request may comprise a subscription or a one-time request. The application service profile may be similar to the application service type e.g. V2X, IOT, eMBB, or the application type within a service type (e.g. platooning application within V2X service type). The application service profile may indicate whether it is group based, the KPIs to be used, application traffic types and schedules.

The collection of service API logs is based on the application service profile or requirement, the API availability at the area of validity, the permissions of the consumer, the exposure capabilities of the API producer of the target API, or a combination thereof. The permissions of the consumer may vary and can be read or written accordingly. The permissions of the consumer may recommend a change or cancel an action previously executed. The API producer can be the service producer or another entity on behalf of the service producer (e.g. an exposure function).

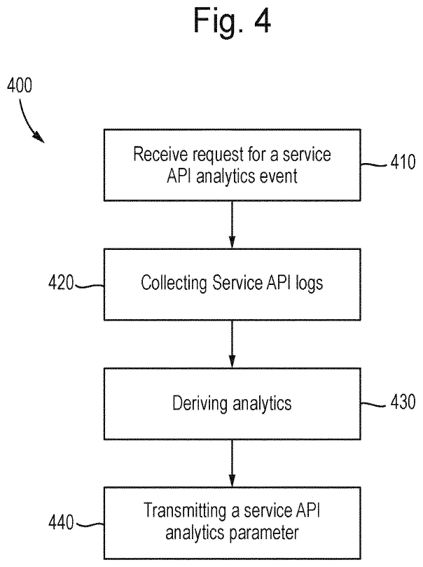

FIG. 4 illustrates a method 400 in a network node of a wireless communications system, the method 400 is for providing analytics for one or more service APIs to a consumer of a service API, the service API for a service produced by one or more service producers at the wireless communications system. The method 400 comprises receiving 410 a request for a service API analytics event from the consumer, the request comprising a requirement for service API information. The method 400 further comprises collecting 420 service API logs from one or more service API sources based on the service API analytics event. The method 400 further comprises deriving 430 analytics for the one or more service APIs based on the collected service API logs to produce at least one service API analytics parameter. The method 400 further comprises transmitting 440 the service API analytics parameter to the consumer.

The wireless communications system comprises one or more network nodes and one or more wireless communications devices. The network node may comprise an application enablement layer (e.g. SEAL, EES), the API-LSE, CCF, HTTP logs server, API logs server, or a CAPIF entity, for example. The set of API logs can be collected or fetched at the network node.

The request may comprise a request to anonymize and/or hide API invoker's identity. The type of the consumer may correspond to one or more of: a consumer being a further network node, a consumer being a trusted 3^{rd} party application, an un-trusted 3^{rd} party application, an application enablement server or client, an application data analytics enablement server or client, a CAPIF entity, a management domain service or function.

The service API may relate to a service produced by a plurality of service providers. The service API may be a control plane API, an OAM API, an edge API, or a client-server API, for example. The service API type may be defined as the set of service APIs which are being invoked to expose similar service (or service targeting the same resources and parameters). One example of service API type is the Location API, or QoS monitoring API which may be provided by different entities and sometimes with different granularity and reporting requirements.

The service producer and service API producer may be the same entity, however it is possible that the service API producer is different. For example, the service API producer may be a gateway function. The gateway function may be, for example, NEF, EGMF, AEF.

The service area may be the coverage area over which the service is provided, and can be represented as the geographical area (set of coordinates), the topological area (set of cells), the data network area (the set of EDNs), or civic addresses, for example. The service area may also be defined in the time dimension, for example the time for which a service is requested at the target area. The step of deriving analytics may comprise configuring, and or anonymizing the API logs.

The network node may comprise a control entity at a communications platform. The control entity may be for at least one wireless communication network. The communications platform may be an edge or cloud or a middleware platform operated by a network operation. The communications platform may be an edge and/or cloud provider or a third-party vertical service provider.

The request for a service API analytics event may comprise an application service profile or requirement, an API identifier, an API type, a time horizon for the analytics event, an area of validity, a reporting configuration, or a combination thereof. The request may comprise a subscription or a one-time request. The application service profile may be similar to the application service type e.g. V2X, IOT, eMBB, or the application type within a service type (e.g. platooning application within V2X service type). The application service profile may indicate whether it is group based, the KPIs to be used, application traffic types and schedules.

The collection of service API logs may be based on the application service profile or requirement, the API availability at the area of validity, the permissions of the consumer, the exposure capabilities of the API producer of the target API, or a combination thereof. The permissions of the consumer may vary and can be read or written accordingly. The permissions of the consumer may recommend a change or cancel an action previously executed. The API producer can be the service producer or another entity on behalf of the service producer (e.g. an exposure function).

The consumer may be a third-party application server, an application of a UE, an API invoker, an AF or a combination thereof.

Deriving analytics for the one or more service APIs may comprise predicting or prescribing the API future status based on the request. Deriving analytics for the one or more service APIs may comprise producing at least one service API analytics parameter based on collected service API logs and the requirement for service API information.

The service API analytics may be derived based on historical API logs, real-time API data corresponding to ongoing API invocations, or a combination thereof.

The requirement for service API information may comprise a level of exposure and/or abstraction of the service API information, and wherein the processing of the API logs is performed according to the level of exposure and/or abstraction of the service API information indicated in the requirement for service API information. The processing of the API logs may comprise aggregating API logs retrieved from a plurality of API invokers and anonymizing them.

The service API may comprise a Network Exposure Function (NEF) API, an Operation Administration and Management (OAM) API, an enablement API, a Mobile Edge Computing (MEC) API, a Radio Access Network Intelligent Controller (RIC) API, a slice API, a client-server API, a local UE API, or a combination thereof. The RIC API may be defined in O-RAN for near-RT RIC. The RIC API may be between the RIC modules and the xApps in O-RAN architecture. The enablement API may comprise an API between the enablement layer and the application specific layer. The enablement API may be a SEAL-S API for example (as specified in 3GPP TS23.434 v17.4.0), or an EDGE-3 and EDGE-5 APIs (as specified in 3GPP TS 23.558 v17.2.0). The client-server API may be between an enablement server and an enablement client. Example of such API is EDGE-1 and EDGE-4 in 3GPP TS 23.558 v17.2.0. The local UE API may be between the application of the UE and the enablement layer of the UE or UE modem. The slice API may be a bundled API tailored for a given slice (e.g. V2X slice API comprises a set of NEF APIs, OAM APIs, client-server APIs).

The derived analytics may be related to the client-server APIs and can be based on a notification method. The notification method may comprise at least one of websockets, long polling, or be OEM specific e.g. Apple Push Notification Service (APNS).

At least one of the one or more service APIs may be a client-server API, and the at least one service API analytics parameters may predict or prescribe an optimal notification method for a given area and time horizon.

The wireless communication system may comprise a plurality of networks, each network operated by a different network operator. The API logs may be obtained from each of the plurality of networks. At least one of the one or more service APIs may be produced by a plurality of wireless communications networks. The derived analytics for the one or more service APIs may predict or prescribe a particular wireless communications network to be used from the plurality of wireless communications networks, for a future API invocation for a given service area.

The service area may include a time horizon. The plurality of wireless communications networks may be operated by different operators. The operators may be mobile network operators (MNOs). The wireless communications network may comprise a domain within a network. The domain may comprise RAN, CN, edge and/or cloud.

This document presents a solution that provides new functionality for API analytics enablement by way of an API Analytics Enabler residing at an edge/cloud platform.

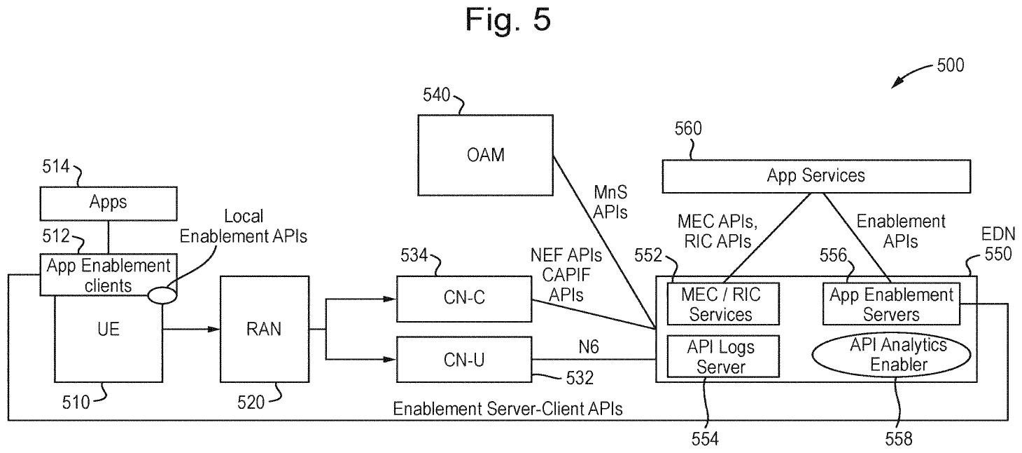

FIG. 5 illustrates a system 500 for implementing a solution presented herein. The system 500 comprises a UE 510, a RAN 520, a Core Network User plane function (CN-U) 532, a Core Network Control plane function (CN-C) 534, an OAM 540, an EDN 550 and at least one Application Server 560. The UE 510, the RAN 520, the CN-U 532, the CN-C 534, the OAM 540, and the EDN 550 are elements of a wireless communications system. The UE 510 comprises Application Enablement Clients 510, and is arranged to execute Applications 514. The Applications 514 and Application Servers 560 are external to the wireless communications system. The EDN 550 comprises a MEC 552, which may provide RIC services, an API Logs Server 554, at least one Application Enablement Server 556, and an API Analytics Enabler 558. The UE 510 may be a UE 110, 200, 610. Each of the Application server 560 and edge data network 550 may comprise a network node 300. The API Analytics Enabler 558 may be an application enablement server, such as SEAL, ADAES, or EES, for example.

The API analytics enabler 558 comprises a processor arranged to: predict API availability, performance and load based on an Application Server/Client request; hide the API invokers information (other than the requestor) before exposing the aggregated API analytics; and prescribe API change for a given service, based on monitoring.

The API analytics enabler 558 further comprises a transceiver arranged to receive an analytics request for API analytics for one or more service APIs; request/receive API logs for the target service APIs; and transmit the requested API analytics.

In operation, a subscription request is received by the API analytics enabler 558 for performing API analytics for one or more service APIs. The service APIs may relate to a service exposed in the wireless communications network. The subscription request includes the event ID for API analytics provision, as well as the service area, PLMN ID, domain ID (e.g. MD ID), exposure gateway ID (e.g. NEF ID, SEAL ID), application/UE session ID. The service area may be defined by topological, geographical, civic addresses, EDN service area, or even temporally.

The subscription request may include the exact APIs, or the API type without specifying the source (for example analytics for UE Location API in a given service area). This request may also indicate the PLMN ID of the requested API analytics. For example, it may happen that multiple PLMNs can provide a service and the App Server needs to be aware on the best API producer to select among different MNO networks.

The API analytics enabler 558, upon receiving the request, if the event type is not for specific API but for an API type, maps the API type to the available APIs in a given service area which was defined at the request. As an example of a “Location API” type, the API analytics enabler maps to “5GC #1 provided service API”, “5GC #2 provided service API”, SEAL LMS #1 provided, UE provided service API, MEC platform.

The API analytics enabler 558 then requests from an API logs Server 554 API logs for the target service API (based on the request or the mapping of of the API type to the available APIs).

The API analytics enabler 558 receives API logs for the target service APIs based on the request. Logs include the API invocation success/errors, API throttling/rate limitation events, number of API invocations for a given time and area and/or slice. The report sent in response may also include the list of API invokers' IDs (or anonymized the number of API invokers), list of IP addresses (if not anonymized), service API name, version, invoked operations, input parameters, invocation result, time and area information. Also, the API exposing identity information can be reported (the exposing function e.g. AEF, NEF, EGMF which provided the logs to the API logs server 554.

The API analytics enabler 558 derives analytics based on the logs for the target service APIs. Such analytics can be statistics or predictions or prescriptions for the API expected usage and availability for a given area and time horizon based on the request. An example output can be: the predicted number of invocations of a NEF API at EDN area #1 between 3 pm-4 pm and date xx will be 1000, the predicted success ratio of invocations, the API load prediction, the predicted throttling events or rate limitation events.

Also, the API analytics report may include the prediction per notification method e.g. http long polling (pull) or websockets (push) or prescription of what notification method shall be preferred for a given API.

Then, the API analytics enabler 558 sends the requested analytics to the third party consumer.

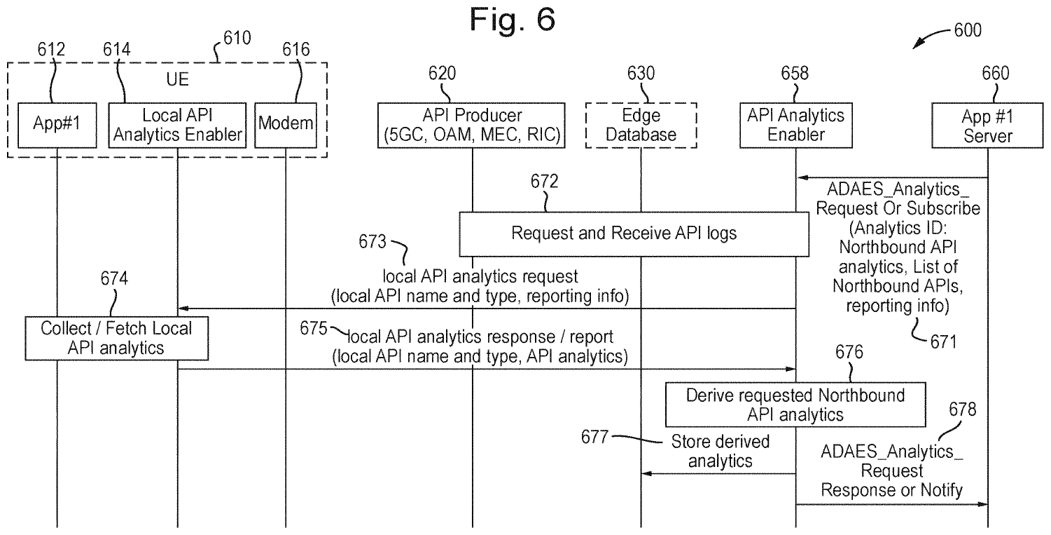

FIG. 6 is a signaling diagram illustrating a method 600 illustrating the role of API analytics enabler as part of an SA6 defined Application Data Analytics Enablement Server (ADAES) or Application Data Analytics Enabler Client (ADAEC). The illustrated system comprises a UE 610, an API producer 620 within the wireless communications network, an edge database 630, an API Analytics Enabler 658 and an Application Server 660. The UE 610 comprises an application (App #1) 612, a local API Analytics Enabler 614 and a modem 616 for communication with the wireless communications network. The UE 610 may be a UE 110, 200, 510. Each of the API Producer 620 and App server 660 may comprise a network node 300.

The method 600 commences at 671 with the consumer making a subscription request for collecting API logs to the API Analytics Enabler (AAE) 658. The consumer may be any one of: the Application Server 660, the API Provider 620, the Application 612 executed by the UE 610, or an ADAES. AAE 658 is a middleware functionality for analytics enablement, which may be implemented in a server, an ADAES, or may be implemented by way of a new component at a logs service producer or mediator between the edge database 630 and the consumer. The functionality of AAE 658 can be provided at an HTTP logs server, or an edge API logs database or a SEAL server.

The request of step 671 may include the requestor ID (e.g. App Server ID, VAL server/client ID), the UE ID or App ID for which the API logs request applies (e.g. external UE ID), the area and time of validity of the request, the analytics event ID=“API logs analytics”, the API name (e.g. SEAL API x, NEF API y, etc. . . . ) and type/info. As an alternative to the API name, the subscription may provide the telco service API type for which analytics exposure is needed (e.g. Location API, QOS API, RNIS API). The telco service API type is a type of API that is used in the wireless communications network.

Once the subscription request is received, AAE 658 may authorize the subscription request. The authorization process may include the AAE 658 interacting with the management & orchestration system.

At 672, the AAE 658 request from a database, API invocation logs for the target API. The AAE 658 may request from the database API invocation logs for a plurality of target APIs, if the type of API is provided. The database may be the edge database 630, an Analytical Data Repository Function (ADRF), an embedded database at the platform where the logs server resides, or this can be an API Logs Service Enabler (API-LSE). In response to the request the AAE 658 receives the requested API invocation logs.

At 673, the AAE 658 requests API logs analytics which include statistics and/or predictions based on historical or real-time client-server API status information. The request is sent for APIs related to the UE, which may be client-server APIs, local UE APIs. The AAE 658, acting as an ADAES, may send the request to the UE application 612 or to a dedicated analytics enabler client (e.g. Application Data Analytics Enabler Client (ADAEC)). The requested API status info may include statistics or predictions for the number of ongoing API calls for the target API, success rate of invocations, API failure or throttling events etc. Also, this request may include the reporting of logs for a given API notification method (WebSocket, long polling, OEM specific) that is used for the target API. The request will include the analytics ID=“local API logs analytics”, the app ID, the UE ID, the originated requestor ID, the reporting configuration, the data analytics granularity (real time, offline, semi-static), the type of analytics (stats, predictions), the target API name or type, group ID (for group-based communications), slice ID, etc.

At 674, the local API Analytics Enabler 614, acting as an AAE client collects the requested API status information from one or more application at the UE 610. The collected API status information may include historical API status info as well as real-time API logs info for the ongoing subscriptions. Based on this collection, the local API Analytics Enabler 614 may perform local API logs analytics based on the analytics event ID. The local API Analytics Enabler 614 may be implemented by an ADAEC (if UE has such capability) or a dedicated application client at the UE 610.

At 675, the local API Analytics Enabler 614 sends to the AAE 658 the requested analytics as a either a response or a report. The local API Analytics Enabler 614 may also abstract the API logs, for hiding the local application information (other than the requestor) before exposing the API logs analytics. An example of local analytics output can be: predictions or statistics for the number of invocations of a client-server API at EDN area #1 between these dates and times are 1000, the success ratio of invocations, the API load information, the logs analytics on predicted throttling events or rate limitation events, the analytics per notification method used (WebSocket, long polling, OEM specific).

At 676, the AAE 658 derives analytics on the target northbound API based on the logs received from the API producer 620 and/or API-LSE and optionally the analytics received by the UE in step 675. Such analytics may comprise predictions and/or statistics for the API status based on the analytics event and may also provide prescription or recommendation on the API to utilize for a given service API type. For example, for Location API type, the AAE server may prescribe the use of SEAL API instead of NEF API due to expected load of NEF API for location exposure. The AAE 658 may also derive the impact of a certain API prediction to the required service (for example what this will mean for a V2X service if API x is used instead of API y). This tends to allow the application server 660 to select the best API and method and adapt accordingly.

At 677, the AAE 658 sends the requested analytics to the consumer based on the initial request at 671.

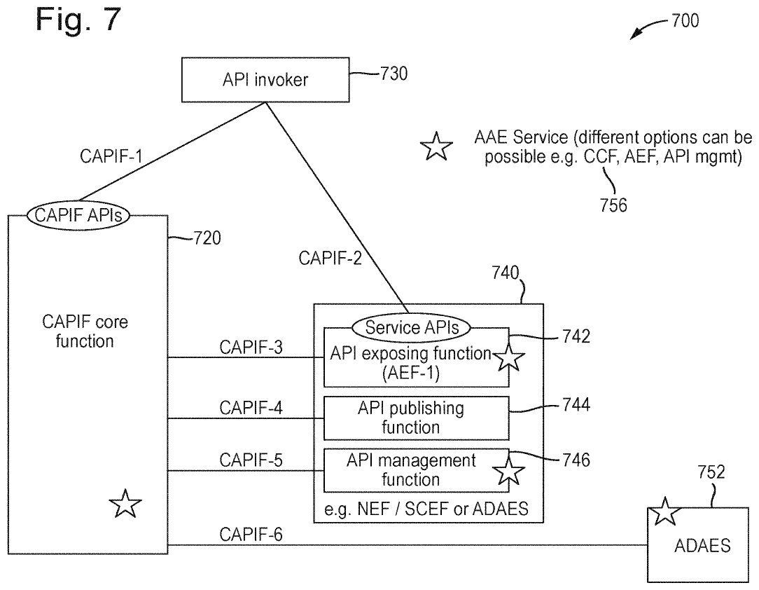

FIG. 7 illustrates a system 700 for implementing another solution presented herein. This is for the case when CAPIF is used for the northbound API exposure. The AAE functionality may be located in different CAPIF entities based on the implementation (e.g. in AEF, CCF, API Management Function) or can be an enablement entity (e.g. ADAES) which provides services to the CAPIF entities. Also, there can be interaction between multiple CAPIF domains and inter-CCF communication may be required.

The system 700 comprises a Common API Framework (CAPIF) core function 720, an API invoker 730, an NEF 740, and an ADAES 752. The NEF 740 may alternatively comprise an SCEF or an ADAES. The NEF 740 comprises an API exposing function (AEF-1) 742, and API publishing function 744, and API management function 746. AAE Service 756 may be implemented at any of the locations indicated by a star in FIG. 7. The AAE Service 756 may be implemented at one or more of the following entities: the CCF 720, the API exposing function (AEF-1) 742, the API management function 746, and the ADAES 752. The API invoker 730 may be a UE 110, 200, 510, 610, a network node 130, 300, or a server 560, 660.

The AAE Service 756 provides one or more of the following capabilities to the CAPIF function 720: API analytics enablement capability; Store, Derive, and Expose service API analytics aggregately for multiple invocations; Authorize and anonymize other invoker's information.

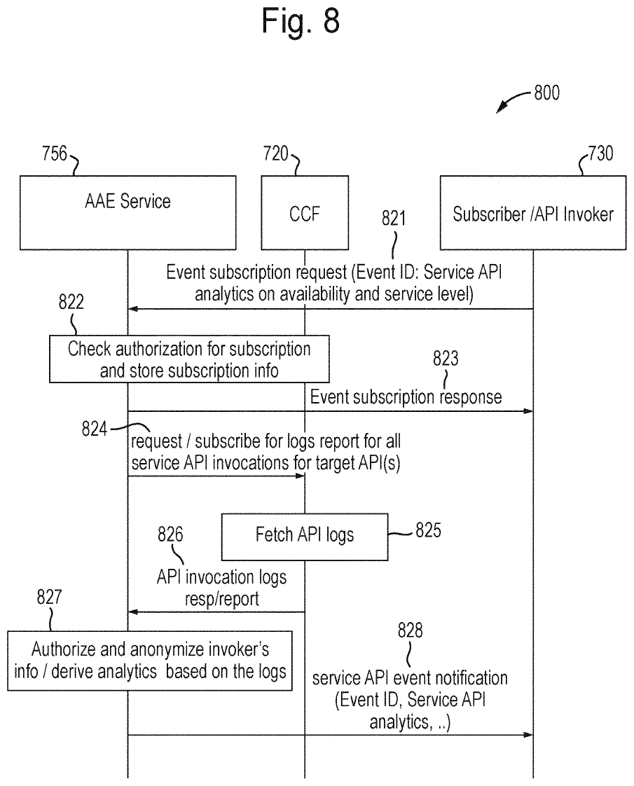

FIG. 8 illustrates a method 800 of operation of the system 700. Method 800 commences at 821 with a subscribing entity 730 (which may be the API invoker 730, a CAPIF entity, an application server, or an application client) sending an event subscription request to the AAE Service 756, the subscription request for analytics for one or more service APIs. Table 4 gives an example of such an event subscription request.

TABLE 4
Event subscription request

| Information element | Status | Description |
|---|---|---|
| Identity information | M | The information to determine the |
| | | identity of the subscribing entity |
| Service API | M | The service API name or type |
| information | | |
| UE ID and address | O | The identity and address of the UE for |
| | | which the service API is invoked (ID |
| | | can be the GPSI) |
| Analytics event ID | M | The event criteria include event type |
| and criteria | | information relevant to the prediction |
| | | or stats on the number of failure API |
| | | invocations, API availability, |
| | | frequency and occurrence of API |
| | | version changes, API location |
| | | changes for the target API, etc |
| Time Validity and | O | Time validity of the request and time |
| horizon | | horizon for the predictions |
| Area of interest | O | Geographical or service or topological |
| | | area for which the subscription applies |
| S-NSSAI, DNN | O | Slice and DNN corresponding to the |
| | | API invoker |
| Notification | O | The information of the subscribing |
| reception | | entity for receiving the notifications |
| information | | for the event. |

At 822, upon receiving the event subscription request from the subscribing entity, the AAE Service 756 checks for the relevant authorization for the event subscription. If the authorization is successful, the AAE Service 756 stores the subscription information.

At 823, the AAE Service 756 sends an event subscription response to the subscribing entity 730 indicating successful subscription.

At 824, upon sending the subscription response, the AAE Service 756 collects API logs to be used to derive analytics and accordingly, the AAE Service 756 triggers API invocation log pull request towards the CAPIF core function 720. The API invocation log pull request indicates the API (or list of APIs) for which logs are required. The API invocation log pull request may include the information elements as exemplified in table 5.

TABLE 5
API invocation log pull/fetch request information elements

| Information element | Description |
|---|---|
| Originated API invoker | Identity information of the originated |
| information | application querying service API log |
| | request |
| AAE ID/Security | Identity information of the AAE |
| credentials | |
| Service ID or UE ID | Identity of the application service or UE |
| | for which the API invocations apply |
| Target API information/ | Information on target API or list of |
| List of API information | target APIs |
| >Query information | List of query filters such as invoker's ID |
| | and IP address, service API name and |
| | version, input parameters, and |
| | invocation result |
| >API aggregation | What type of aggregation or a |
| abstraction flag | bstraction/filtering needs to be applied |
| Reporting format | The logs reporting configuration |
| configuration | (frequency, periodicity etc) |
| Area of validity | The geographical area for which the |
| | request applies |
| Time or validity | The time of validity for the request |
| Exposure level | The level of exposure requirement (e.g. |
| requirement | permissions on the logs like read/write/ |
| | delete . . . ) for the logs to be exposed |

At 825 the CCF 720 authorizes the request and fetches the API logs from a storage unit. Then, at 826, the CCF 720 sends the requested information to the AAE Service 756 via an API invocation log pull/fetch response message. This message may include the information elements shown in table 6.

TABLE 6
API invocation log pull/fetch response message

| Information element | Description |
|---|---|
| Result | Identity information of the originated application |
| | querying service API log request |
| Service ID or UE ID | Identity of the application service or UE for which |
| | the API invocations apply |
| Target API information/ | Information on target API or list of target APIs |
| List of API information | |
| >API Logs Collection | The API logs based on the subscription event. |
| Event | This includes for example the number of failure |
| | API invocations, API availability, frequency and |
| | occurrence of API version changes, API location |
| | changes for the target API, API throttling events, |
| | number of API invocations for a given area and |
| | time etc |
| >reporting info | The time and area for which the reporting applies |

At 827, the AAE Service 756 authorizes and anonymizes the API logs (if this was not performed by the CCF 720) and abstracts based on exposure level. The exposure level can be known based on pre-configuration by the OAM or based on the subscription and type of API invoker 730. The AAE Service 756 then derives analytics on the target service API(s) based on the logs received from the CCF 720 and/or the API-LSE. Such analytics may comprise predictions and/or statistics for the API status based on the analytics event and may also provide a prescription or recommendation on the service API to utilize for a given service API type.

At 828, the AAE Service 756 sends the analytics as event notifications to all the subscribing entities that have subscribed for the event matching the criteria. If a notification reception information is available as part of the subscribing entity event subscription, then the notification reception information is used by the AAE Service 756 to send event notifications to the subscribing entity. The notification may include the following parameters: the analytics event ID, the service API name and/or type, stats or predictions based on abstracted or anonymized API logs (for example number of failure API invocations, API availability, frequency and occurrence of API version changes, API location changes for the target API, API throttling events, number of API invocations for a given area and time, API load statistics for a given edge network, etc), the time and area where the reporting occurs and is valid.

It should be noted that the AAE Service 756 can be also deployed as new MEC capability/service in ETSI MEC architecture or as a new RIC service in O-RAN architecture.

There is provided herein a new capability at the application enablement layer (in ADAES or SEAL or SEAL-DD) for API logs collection and deriving analytics for the requested APIs or API types, assuming different types of APIs within a wireless communications network. The described capability covers the client-server APIs and can be used to expose information based on the API notification method; signaling over SA6/RIC/MEC defined interfaces for operating API-LSE (impact depends on the implementation).

Using API analytics as described herein tends to provide the benefit that of the application server determining from which service/API producer to request a service. For example, this may apply in the case when a vertical service provider can select from multiple platforms or PLMNs to obtain a service, each using a different API, and the vertical service provider attempts to determine the optimal API to use.

In one arrangement described herein, the role of API analytics enabler as part of 3GPP SA6 ADAES/ADAEC is defined. In such a scenario, the enabler collects logs from an edge database and also data/analytics on local APIs from one or more UEs. This advantageously introduces a value-added service on top of an API logs server (e.g. HTTP server) to collect logs from heterogenous API producers and the prediction of the API status/conditions for different types of APIs. Such capability may include also the predictive selection among different API producers or domains (e.g. different MNOs or different platforms) which can be candidate to offer similar service information (e.g. QoS monitoring or Location reporting for a UE).

In another arrangement described herein, a CAPIF is used for the northbound API exposure. The AAE functionality may be located in different CAPIF entities based on the implementation (e.g. in AEF, CCF, API Management Function) or can be an enablement entity (e.g. ADAES) which provides services to the CAPIF entities. Also, there can be interaction between multiple CAPIF domains and inter-CCF communication may be required.

According to such arrangements, where the CAPIF currently is storing logs, it may also provide logs to API management function. However, the service API logs are stored and fetched for a given API invoker. In this implementation, the analytics based on the API logs (e.g. historical and real time data) for a given service API (but for all API invokers) are derived to allow CCF to store and process not only API logs but also API analytics. Such analytics can be exposed as a service to the subscriber (e.g. API invoker).

Accordingly, there is provided a method for providing analytics for one or more service APIs to a consumer, the method comprises: receiving a request for a service API analytics event from a consumer; determining to collect API logs from one or more API producers or a logs server based on the service API analytics event; deriving analytics for the one or more service APIs based on the collected API logs; transmitting the service API analytics to the consumer. The method may be performed at an AAE, ADAES, or CAPIF function. The request for a service API analytics event may include the API name or API type.

The request may comprise an application service profile or requirement, an API identifier, an API type, a time horizon for the analytics event, an area of validity, a reporting configuration, or a combination thereof.

The determination to collect API logs may be based on the application service profile or requirement, the API availability at the area of validity, the permissions of the consumer, the exposure capabilities of the API producer of the target API, or a combination thereof.

The consumer is a third-party application server, an application of a UE, an API invoker, an AF or a combination thereof.

Deriving analytics may comprise predicting or prescribing the API future status based on the request.

The service API analytics may be derived based on historical API logs, real-time API data corresponding to ongoing API invocations, or a combination thereof.

The service API may comprise a NEF API, an OAM API, an enablement API, a MEC API, a RIC API, a slice API, a client-server API, a local UE API, or a combination thereof.

The analytics related to the client-server APIs may be based on the notification method. The notification method may comprise websockets, long polling, OEM specific e.g. APNS.

The analytics related to the client-server APIs may predict or prescribe an optimal notification method for a given area and time horizon. The analytics may predict the operator's network to be used for a future API invocation for a given area and time horizon.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network node for wireless communication, comprising:
at least one memory; and
at least one processor coupled with the at least one memory and configured to cause the network node to:
receive, from a consumer of a service application programming interface (API), a request for a service API analytics event, the request comprising a requirement for service API information;
collect service API logs from one or more API sources based at least in part on the service API analytics event;
derive analytics for one or more service APIs based at least in part on the service API logs to produce at least one service API analytics parameter; and
transmit, to the consumer, the at least one service API analytics parameter.

2. The network node of claim 1, wherein the request for the service API analytics event comprises one or more of an application service profile, an application service requirement, an API identifier, an API type, a time horizon for the service API analytics event, an area of validity, or a reporting configuration.

3. The network node of claim 1, wherein a collection of the service API logs is based on one or more of an application service profile, an application service requirement, an API availability in an area of validity, permissions of the consumer, or exposure capabilities of an API producer of a target API.

4. A method performed by a network node, the method comprising:
receiving, from a consumer of a service application programming interface (API), a request for a service API analytics event, the request comprising a requirement for service API information;
collecting service API logs from one or more service API sources based at least in part on the service API analytics event;
deriving analytics for one or more service APIs based at least in part on the service API logs to produce at least one service API analytics parameter; and
transmitting, to the consumer, the at least one service API analytics parameter to the consumer.

5. The method of claim 4, wherein the request for the service API analytics event comprises one or more of an application service profile, an application service requirement, an API identifier, an API type, a time horizon for the service API analytics event, an area of validity, or a reporting configuration.

6. The method of claim 4, wherein a collection of the service API logs is based on one or more of an application service profile, or an application service requirement, an API availability in an area of validity, permissions of the consumer, or exposure capabilities of an API producer of a target API.

7. The method of claim 4, wherein the consumer is one or more of a third-party application server, an application of a user equipment (UE), an API invoker, an application function (AF), or an additional network node.

8. The method of claim 4, wherein deriving the analytics for the one or more service APIs comprises predicting or prescribing an API future status based on the request.

9. (canceled)

10. The method of claim 4, wherein service API analytics are derived based on one or more of historical API logs, or real-time API data corresponding to ongoing API invocations.

11. The method of claim 4, wherein a service API comprises one or more of a network exposure function (NEF) API, an operation administration and management (OAM) API, an enablement API, a mobile edge computing (MEC) API, a radio access network intelligent controller (RIC) API, a slice API, a client-server API, or a local UE API.

12-15. (canceled)

16. The network node of claim 1, wherein the consumer is one or more of a third-party application server, an application of a user equipment (UE), an API invoker, an application function (AF), or an additional network node.

17. The network node of claim 1, wherein, to derive the analytics for the one or more service APIs, the at least one processor is configured to cause the network node to predict or prescribe an API future status based on the request.

18. The network node of claim 1, wherein service API analytics are derived based on one or more of historical API logs, or real-time API data corresponding to ongoing API invocations.

19. The network node of claim 1, wherein a service API comprises one or more of a network exposure function (NEF) API, an operation administration and management (OAM) API, an enablement API, a mobile edge computing (MEC) API, a radio access network intelligent controller (RIC) API, a slice API, a client-server API, or a local UE API.

20. A processor for wireless communication, comprising:
at least one controller coupled with at least one memory and configured to cause the processor to:
receive, from a consumer of a service application programming interface (API), a request for a service API analytics event, the request comprising a requirement for service API information;
collect service API logs from one or more service API sources based at least in part on the service API analytics event;
derive analytics for one or more service APIs based at least in part on the service API logs to produce at least one service API analytics parameter; and
transmit, to the consumer, the at least one service API analytics parameter to the consumer.

21. The processor of claim 20, wherein the request for the service API analytics event comprises one or more of an application service profile, an application service requirement, an API identifier, an API type, a time horizon for the service API analytics event, an area of validity, or a reporting configuration.

22. The processor of claim 20, wherein the consumer is one or more of a third-party application server, an application of a user equipment (UE), an API invoker, an application function (AF), or an additional network node.

23. The processor of claim 20, wherein, to derive the analytics for the one or more service APIs, the at least one controller is configured to cause the processor to predict or prescribe an API future status based on the request.

24. The processor of claim 20, wherein service API analytics are derived based on one or more of historical API logs, or real-time API data corresponding to ongoing API invocations.

25. The processor of claim 20, wherein a service API comprises one or more of a network exposure function (NEF) API, an operation administration and management (OAM) API, an enablement API, a mobile edge computing (MEC) API, a radio access network intelligent controller (RIC) API, a slice API, a client-server API, or a local UE API.
